(19) United States
(12) Patent Application Publication
(10) Pub. No.: US 2006/0131872 A1
(43) Pub. Date: Jun. 22, 2006

(54) Reinforced fitting and pipe

(75) Inventor: Antonio J. Roig, Ponce, PR (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Vassallo Research & Development Corporation

(21) Appl. No.: 11/284,124

(22) Filed: Nov. 22, 2005

Related U.S. Application Data
(60) Provisional application No. 60/629,980, filed on Nov. 23, 2004.

(51) Int. Cl. F16L 39/00

(52) U.S. Cl. 285/133.5

(57) ABSTRACT

A reinforced fitting and pipe is provided that has increased durability during installation and service. The fitting and pipe may be formed with reinforcement ribs along a portion of the body and an annular reinforcing ring spaced inwardly from each end of the pipe and fitting. The reinforcement ribs and annular rings increase the durability and resistance to stress of the fitting and pipe, thereby avoiding the expense and time normally required for replacement or repair of a fitting and pipe that quickly fails. The fitting and pipe may have a tapered portion to further increase the stiffness of the bell portion. The bell portion of a fitting and pipe may further have a substantially Z-shaped configuration to further increase the stiffness of the bell portion.

### CROSS REFERENCE TO RELATED APPLICATION

This application claims the benefit under 35 U.S.C. § 119(e) of U.S. Provisional No. 60/629,980, filed Nov. 23, 2004.

### FIELD OF THE INVENTION

The present invention relates to a reinforced pipe or fitting. More particularly, the present invention relates to a fitting and pipe having a reinforced bell portion. Still more particularly, the present invention relates to a fitting and pipe having reinforcement ribs along a portion of the body of the fitting and pipe and annular reinforcing rings disposed proximal each end of the bell portions. The reinforced fitting and pipe has increased strength and durability during installation and service.

### BACKGROUND OF THE INVENTION

Pipe and pipe fittings are often required to be buried and run underground. For example, plastic sewer pipe is normally buried at depths varying from a few feet to, in some cases, thirty feet. During installation, depending on the site condition, soil type, and other factors, the nature of the bedding for fittings and pipe may place undue stress on the pipe and pipe fittings causing them to break. Other conditions, such heavy traffic, including trucks and tractors, driving over the area in which the pipe and pipe fittings are buried further increases the undue stress exerted on the fittings and pipe. Thus, buried pipe and fittings are subjected to various degrees of static and dynamic loads and stresses depending on the type of installation, soil and site conditions, and other factors.

After fittings and pipe have been installed and are in service, they are still subjected to further undue stresses. For example, settling of the soil may place the fittings and pipe under further stress, which also causes fittings and pipe to break, thereby requiring repair or replacement. Repairing or replacing buried fittings and pipe that are in service is a difficult and time consuming task, as well as being inconvenient to those relying on the service being provided by the pipe system. Furthermore, if the fittings and pipe are buried under a roadway, that must be disturbed as well. This provides a further inconvenience to those relying on commuting over the roadway.

Thus, there is a continuing need to provide an improved reinforced fitting and pipe having increased strength and durability during installation and service.

### SUMMARY OF THE INVENTION

A reinforced fitting and pipe is provided that has increased durability during installation and service. The reinforced fitting and pipe of exemplary embodiments of the present invention takes into account the possible variations of site conditions and various overstressing conditions the fitting and pipe may be subjected to during installation and its service life.

In accordance with one exemplary embodiment of the present invention, a fitting and pipe is formed with reinforcement ribs along a portion of the body and an annular reinforcing ring spaced inwardly on a bell portion at each end of the fitting and pipe. Thus, the reinforcement ribs and annular rings of the present invention increase the durability and resistance to stress of the fitting and pipe, thereby avoiding the expense and time normally required for replacement or repair of fittings and pipe that quickly fail.

In accordance with another exemplary embodiment of the present invention, a reinforced bell member increases the stiffness at each end of the fitting and pipe. Thus, the reinforced bell member increases the durability and resistance to stress of the fitting and pipe, thereby avoiding the expense and time normally required for replacement or repair of fittings and pipe that quickly fail.

In accordance with still another exemplary embodiment of the present invention, a reinforced bell member has a substantially Z-shaped configuration to further increase stiffness of the bell member.

Other objects, advantages and salient features of the invention will become apparent from the following detailed description, which, taken in conjunction with annexed drawings, discloses a preferred embodiment of the present invention.

### BRIEF DESCRIPTION OF THE DRAWINGS

The above and other aspects, features and advantages of the present invention will be more apparent from the following detailed description taken with reference to the accompanying drawings, in which:

FIG. 1 is a front elevational view of a reinforced pipe fitting according to an exemplary embodiment of the present invention;

FIG. 2 is a right side elevational view of the pipe fitting of FIG. 1;

FIG. 3 is a left side elevational view of the pipe fitting of FIG. 1;

FIG. 4 is a rear elevational view of the pipe fitting of FIG. 1;

FIG. 5 is an elevational view in cross section along line 5-5 of a bell portion of the pipe fitting of FIG. 1;

FIG. 6 is an elevational view in cross section of a bell portion of a pipe fitting having a rounded annular ring;

FIG. 7 is an elevational view in cross section of a bell portion of a pipe fitting having an annular ring with a substantially L-shaped cross-sectional configuration; and

FIG. 8 is a front elevational view of a reinforced pipe according to an exemplary embodiment of the present invention.

Throughout the drawings, like reference numerals will be understood to refer to like parts, components and structures.

### DETAILED DESCRIPTION OF THE INVENTION

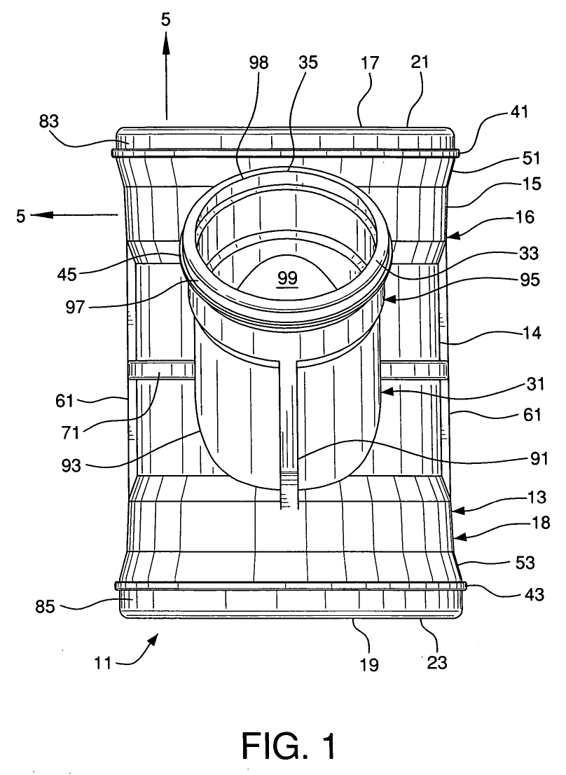

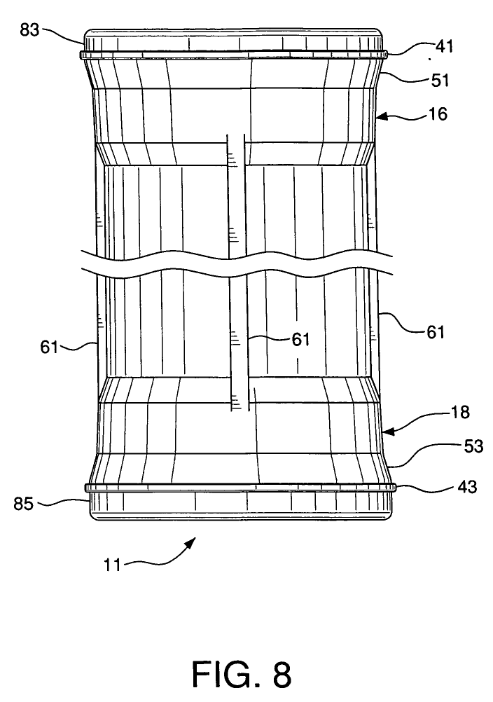

FIGS. 1-4 show a reinforced pipe fitting 11 in accordance with exemplary embodiments of the present invention. Although FIGS. 1-4 show a “wye” fitting, the present invention is equally applicable to any suitable fitting and pipe (FIG. 8), including a “tee” fitting or an elbow. Furthermore, the present invention is suitable to any shape that has a bell portion, including, but not limited to, wyes; tee-wyes; sanitary tees; combination tees of 45 and 60 degrees; bends of 1/16, ⅛, ⅙, ¼ and ¼ long sweep; reducing wyes; reducing tees; reducing tee-wyes; double tees; double wyes; double reducing tees; double reducing wyes; crosses; bushings; and bend of 22.5, 45, 60 and 90 degrees.

As shown in FIGS. 1-4, a reinforced fitting 11 has a first body portion 13 having an outer surface 15, a first end 17 and a second end 19. A first passageway 25 extends between a first opening 21 disposed at the first end 17 and a second opening 23 disposed at the second end 19.

The first body portion 13 has a central portion 14, a first bell portion 16 and a second bell portion 18. The majority of the central portion 13 has an outer diameter less than the outer diameter of the first and second bell portions 16 and 18. Ends of the central portion 14 slope outwardly, as shown in FIG. 1, to the first and second bell portions 16 and 18.

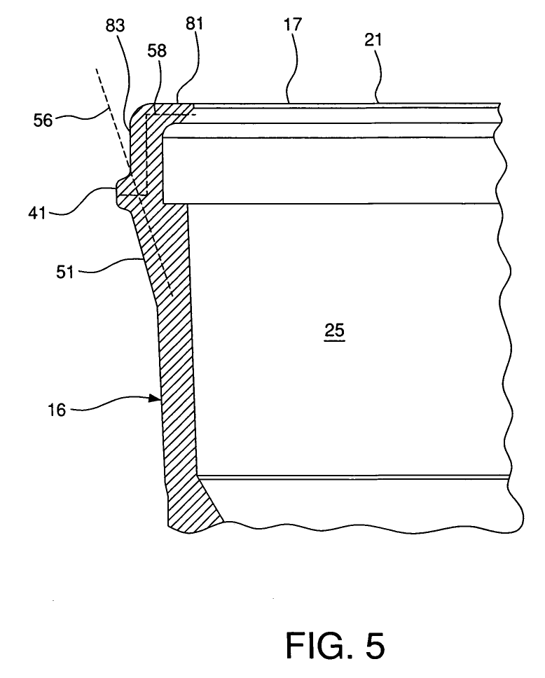

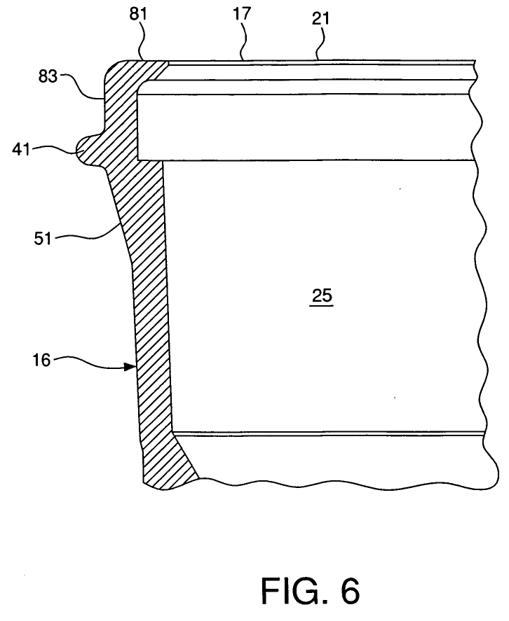

The first and second bell portions 16 and 18 are substantially similarly configured. A first tapered portion 51 of the first bell portion 16 tapers outwardly to a first annular reinforcing ring 41. The first tapered portion 51 is highlighted by the line 56 added to the first bell portion 16 of FIG. 5 to 6 merely illustrate the taper of the first bell portion 16 and is not additional structure. A second tapered portion 53 of the second bell portion 18 tapers outwardly to a second annular reinforcing ring 43. The first and second tapered portions 51 and 53 increase the thickness at each bell portion of the fitting 11, as shown in FIGS. 5-7, thereby increasing the stiffness of the bell portion.

The first and second end portions 83 and 85 of the first and second bell portions 16 and 18 between the first and second annular rings 41 and 43 and the first and second ends 17 and 19, respectively, have a substantially constant outer diameter. As shown in FIGS. 5-7, a first lip 81 extends inwardly at the first end 17 of the fitting 11. Although not shown, a second lip extends inwardly at the second end 19 of the fitting 11. The first annular ring 41, the end portion 83 of the first bell portion 16 and the first lip 81 has a substantially Z-shaped cross-sectional configuration, as illustrated by the Z FIG. 58 added to the first bell portion 16 of FIG. 5, that further stiffens the first bell portion 16 of the fitting 11. The Z FIG. 58 of FIG. 5 merely illustrates the substantially Z-shaped configuration as it not additional structure of the first bell portion 16. The second annular ring 43, the second end portion 85 of the second bell portion 18 and the second lip has a substantially Z-shaped configuration that further stiffens the second bell portion 18 of the fitting. The first and second bell portions 16 and 18 of the fitting 11 are adapted to receive spigot portions of a mating fitting or pipe. The Z-shaped configuration of the bell portion increases the strength and durability of such a joint formed between the bell and spigot portions of mating fittings.

The first annular reinforcing ring 41 extends outwardly from the outer surface 15 of the first bell portion 16 of the first body portion 13. The first annular ring 41 is spaced inwardly from the first end 17 and is proximal thereto, as shown in FIG. 1. The second annular reinforcing ring 43 extends outwardly from the outer surface 15 of the second bell portion 18 of the first body portion 13. The second annular ring 43 is spaced inwardly from the second end 19 and is proximal thereto, as shown in FIG. 1. The first and second annular rings 41 and 43 preferably extend substantially continuously circumferentially on the first body portion 13. The first and second annular rings 41 and 43 stiffen the first and second bell portions 16 and 18 of the fitting 11, respectively, in the area where a mating fitting and pipe is connected.

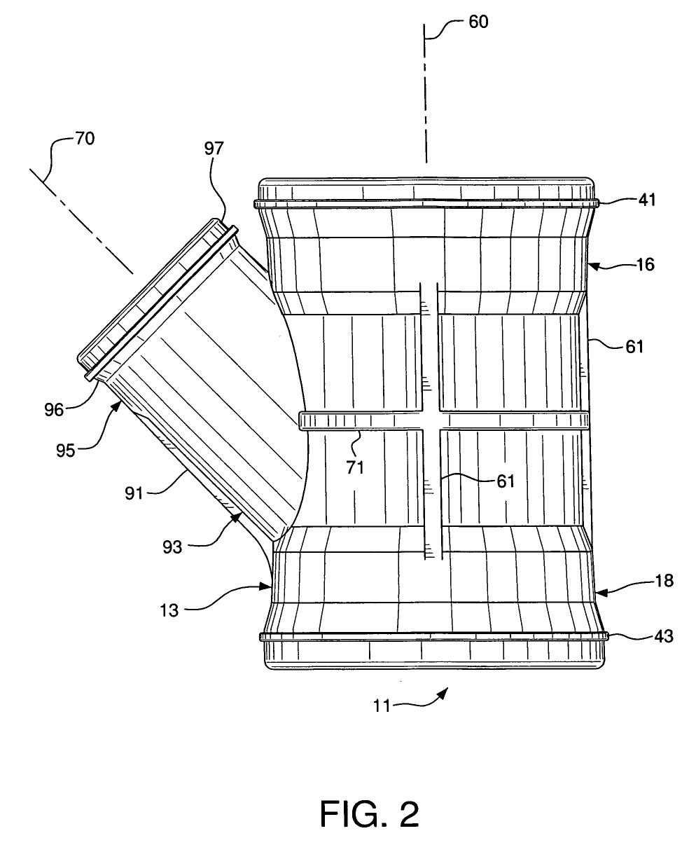

A first set of ribs 61 extend outwardly from the outer surface of the first body portion 13, as shown in FIGS. 1-4, substantially parallel to a longitudinal axis 60 (FIG. 2) of the first body portion 13. Each of the axial ribs 61 of the first set of ribs is preferably equidistantly spaced around the circumference of the first body portion 13, such as spacing four ribs 90 degrees apart. Preferably, the majority of each rib 61 of the first set of ribs extends along the central portion 14 of the first body portion 13.

A second set of ribs 71 extend outwardly from the outer surface of the first body portion 13 around the circumference of the first body portion, as shown in FIGS. 1-4. Preferably, the second set of ribs 71 are substantially perpendicular to the first set of ribs 61.

The fitting 11 may have a second body portion 31 extending outwardly from the first body portion 11 to a third end 33 having a third opening 35. For a tee fitting (not shown), the second body portion 31 extends outwardly from the first body portion 13 at an angle of approximately 90 degrees. For a wye fitting, the second body portion 31 extends outwardly from the first body portion 13 at an acute angle, such as 45 degrees. A second passageway 99 is formed extending between the first passageway 25 and the third opening 35.

The second body portion 31 has a main portion 93 having a substantially constant outer diameter. A distal end (the end not connected to the first body portion) of the main portion 93 tapers outwardly to define the third bell portion 95. The majority of the main portion 93 has an outer diameter less than the outer diameter of the third bell portion 95. A third tapered portion 96 of the third bell portion 95 tapers outwardly to a third annular reinforcing ring 45. The third tapered portions 96 increases the thickness of the third bell portion 95 of the second body portion 31 of the fitting 11, as shown in FIGS. 1-4, thereby increasing the stiffness of the fitting inwardly of the third end 33.

Preferably, the third bell portion 95 is formed substantially similarly to the first bell portion 16, as shown in FIGS. 5-7. The third end portion 97 of the third bell portion 95 between the third annular ring 45 and the third end 33 has a substantially constant outer diameter. A third lip 98 (FIG. 1) extends inwardly at the third end 33 of the second body portion 31 of the fitting 11. The third annular ring 45, the end portion 97 of the third bell portion 95 and the third lip 98 has a substantially Z-shaped configuration that further stiffens the third bell portion 95 of the fitting 11. The Z-shaped configuration increases the strength and durability of such a joint formed between the bell and spigot portions of mating pipes and fittings.

The third annular reinforcing ring 45 extends outwardly from the outer surface of the third bell portion 95 of the second body portion 31. The third annular ring 45 is spaced inwardly from the third end 33 and is proximal thereto, as shown in FIGS. 1-3. The third annular ring 45 preferably extends substantially continuously circumferentially on the first body portion 13. The third annular ring 45 stiffens the third bell portion 95 of the pipe member 11, respectively, in the area where a mating fitting and pipe is connected.

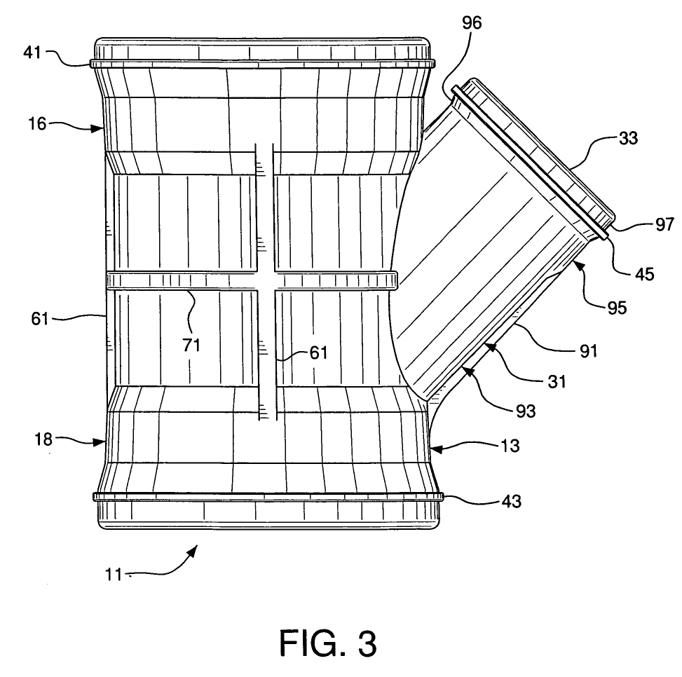

A third set of ribs may extend outwardly from the outer surface of the second body portion 33, as shown in FIGS. 1-3, substantially parallel to a longitudinal axis 70 (FIG. 2) of the second body portion 31. As shown, a single rib 91 extends substantially parallel to longitudinal axis 70 on the portion of the main portion 93 of the second body portion 31 having the largest length, as shown in FIG. 3.

A fitting 11 having reinforcement ribs, annular reinforcing rings and substantially Z-shaped bell portions according to the exemplary embodiments of the present invention assist the fitting and pipe to counteract possible bending moments that may develop between the first and second ends 17 and 19, as well as counteracting flattening along the longitudinal axis 60. The second set of ribs 71 counteract direct deflection from radically oriented direction at the mid-plane.

The third rib 91 on the second body portion 31 counteracts loads trying to separate the second body portion 31 from the first body portion 13. Additionally, the third rib 91 protects the second body portion from bending due to localized loads.

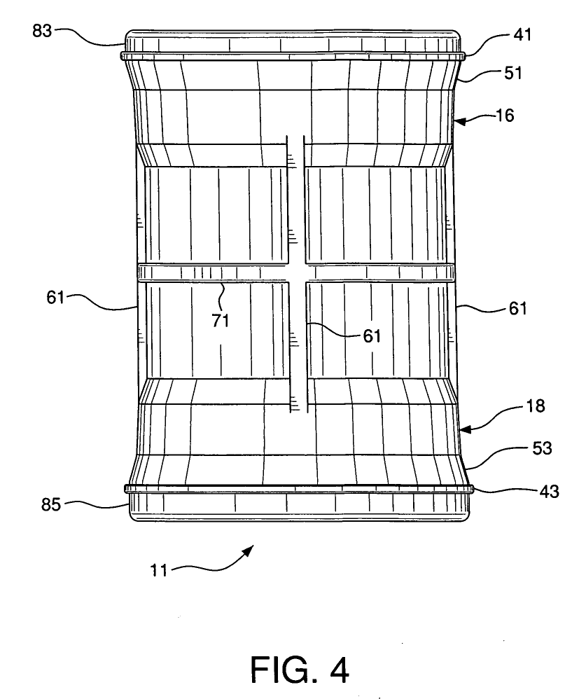

In the exemplary embodiment shown in FIGS. 1-4 of a wye fitting, the first set of ribs 61 includes three ribs spaced approximately 90 degrees apart on the bottom, left and right sides of the pipe member 11. In this exemplary embodiment, there is no fourth axial rib on the first body portion 13 of the pipe member 11 due to the presence of the second body portion 31. In the exemplary embodiment shown in FIG. 8, pipe 11 has four axial ribs 61 spaced approximately 90 degrees apart along the circumference of the pipe. Although not shown, one or more annular or transverse ribs may be placed along the length of pipe 11 in the manner of rib 71 of FIG. 4. A majority of each axial rib 61 of the first set of ribs extends along the central portion 14 of the first body portion 13 and may terminate on the bell portion, as shown in FIGS. 1-4. The second set of ribs 71 includes one rib extending circumferentially around the central portion 14 starting and ending at the second body portion 31, as shown in FIG. 1. The third set of ribs 91 includes one rib extending substantially parallel to the longitudinal axis 70 along the portion of the second body portion 31 having the largest length. Annular rings 41, 43 and 45 are spaced inwardly from and proximal to the first, second and third ends on the first, second and third bell portions 16, 18 and 95, respectively. The annular rings extend substantially circumferentially around the first, second and third bell portions of the fitting 11. First, second and third outwardly tapered portions 51, 53 and 96 are disposed inwardly of the first, second and third annular rings, respectively. Each bell portion of the fitting 11 has a substantially Z-shaped configuration formed by the annular ring, the outer portion and the inwardly extending lip.

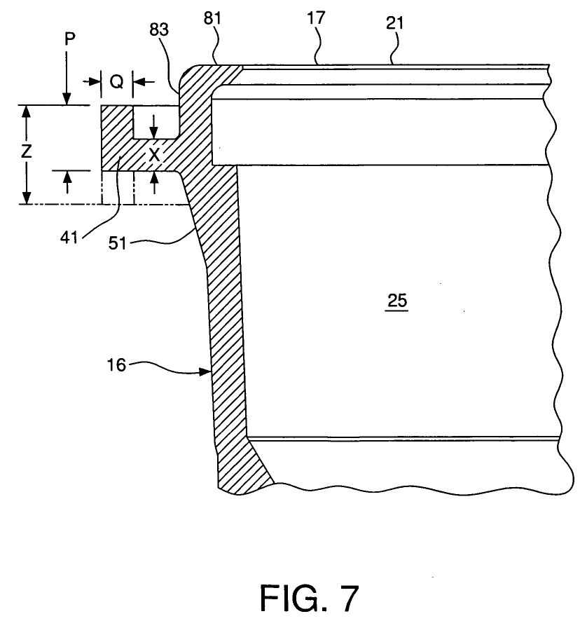

The annular rings may be formed to have any suitable shape, including, but not limited to, square, square with small radiuses to substantially prevent sharp corners, circular (FIG. 6), T-shaped (FIG. 7), and L-shaped (FIG. 7). As shown in FIG. 6, the annular ring 41 is substantially rounded. As shown in solid lines in FIG. 7, the annular ring 41 has a substantially L-shaped cross-sectional configuration. As shown in dashed lines in FIG. 7, the annular ring 41 has a substantially T-shaped cross-sectional configuration. The width of the stem of the annular ring is identified as “X.” The width of the base of the L-shaped annular ring is identified by “P” and of the T-shaped annular ring by “Z.” The height of the base of the annular ring is identified by “Q.” Preferably, for an L-shaped annular ring, the width of the base “P” is at least approximately twice as large as the height of the base “Q” (i.e., P≧2Q). Preferably, for a T-shaped annular ring, the width of the base Z is at least approximately twice as large as the width of the stem X (i.e., Z≧2X). Preferably, for a T-shaped annular ring, the height of the base Q is at least as large as the width of the stem X (i.e., Q≧X).

The fitting and pipe may be made of any material suitable for the intended use of the fitting and pipe. For example, the fitting and pipe may be made of plastic, such as such as poly(vinyl chloride), polyethylene, or the like, and may be used in sewer and pressure (potable) pipe applications. Conventional techniques, such as extrusion and injection molding, may be used to make fittings and pipe according to the exemplary embodiments of the present invention.

While a particular embodiment has been chosen to illustrate the invention, it will be understood by those skilled in the art that various changes and modifications may be made therein without departing from the scope of the invention as defined in the appended claims.

What is claimed is:

1. A reinforced fitting or pipe, comprising:
a first bell portion at a first end; and
a first annular ring spaced inwardly from and proximal said first end and extending outwardly from an outer surface of said first bell portion.

2. A reinforced fitting or pipe according to claim 1, wherein
a first body portion has an outer surface and said first bell portion at said first end and a second bell portion at a second end;
a first passageway extends between a first opening disposed at said first end and a second opening disposed at the second end;
a second annular ring is spaced inwardly from and proximal said second end and extends outwardly from said outer surface of said second bell portion.

3. A reinforced fitting or pipe according to claim 2, wherein
a first set of ribs extends along said outer surface of said first body portion substantially parallel to a longitudinal axis of the passageway; and
a second set of ribs extends along said outer surface of said first body portion substantially perpendicular to said longitudinal axis of said first passageway.

4. A reinforced fitting or pipe according to claim 3, wherein
said first body portion has a central portion between said first and second bell portions having a first outer diameter less than second and third outer diameters at said first and second ends; and
a majority of said first and second sets of ribs extend along said central portion of said first body portion.

5. A reinforced fitting or pipe according to claim 2, wherein
a second body portion extends outwardly from said first body portion and has an outer surface;
a second passageway extends between said first passageway and a third opening disposed in a third bell portion at a third end of said second body portion; and
a third annular ring is spaced inwardly from said third end and extends outwardly from said outer surface of said third bell portion.

6. A reinforced fitting or pipe according to claim 5, wherein
a third set of ribs extends along said second body portion substantially parallel to a longitudinal axis of said second passageway.

7. A reinforced fitting or pipe according to claim 6, wherein
said third set of ribs extends along a portion of said second body portion having the greatest length.

8. A reinforced fitting or pipe according to claim 2, wherein
said first and second bell portions of said first body portion have first and second outwardly tapered portions to increase stiffness of said first and second bell portions.

9. A reinforced fitting or pipe according to claim 5, wherein
said third bell portion of said second body portion has a third outwardly tapered portion to increase stiffness of said third bell portion of said pipe member.

10. A reinforced fitting or pipe, comprising:
a first body portion having an outer surface and first and second bell portions at first and second ends;
a first annular ring spaced inwardly from said first end and extending outwardly from said outer surface of said first body portion;
a first end portion of said first body portion extending from said first annular ring to said first end; and
a first lip extending inwardly at said first end;
wherein said first annular ring, said first end portion and said first lip have a substantially Z-shaped configuration to increase stiffness of said first bell portion.

11. A reinforced fitting or pipe according to claim 10, wherein
a second annular ring is spaced inwardly from said second end and extends outwardly from said outer surface of said first body portion;
a second end portion of said first body portion extends from said second annular ring to said second end; and
a second lip extends inwardly at said second end;
wherein said second annular ring, said second end portion and said second lip have a substantially Z-shaped configuration to increase stiffness of said second bell portion.

12. A reinforced fitting or pipe according to claim 11, wherein
a second body portion extends outwardly from said first body portion to a third end and has an outer surface; and
a third annular ring is spaced inwardly from said third end and extends outwardly from said second body portion outer surface.

13. A reinforced fitting or pipe according to claim 10, wherein
a third end portion of said second body portion extends from said third annular ring to said third end; and
a third lip extends inwardly at said third end;
wherein said third annular ring, said third end portion and said third lip have a substantially Z-shaped configuration to increase stiffness of said third bell portion.

14. A reinforced pipe fitting, comprising:
a first body portion having an outer surface and first and second bell portions at first and second ends;
a first passageway extending between a first opening disposed at the first end and a second opening disposed at the second end;
first and second annular rings spaced inwardly from and proximal said first and second ends, respectively, and extending outwardly from said outer surface of said first body portion;
first and second outwardly tapered portions on said first body portion proximal said first and second ends and spaced inwardly of said first and second annular rings to increase stiffness of said first and second bell portions;
a second body portion extending outwardly from said first body portion and having an outer surface;
a second passageway extending between said first passageway and a third opening disposed in a third bell portion at a third end of said second body portion;
a third annular ring spaced inwardly from said third end and extending outwardly from said second body portion outer surface; and
a third outwardly tapered portion on said second body portion proximal said third end and spaced inwardly of said third annular ring to increase stiffness of said third bell portion.

15. A reinforced pipe fitting according to claim 14, wherein
a first set of ribs extends along said outer surface of said first body portion substantially parallel to a longitudinal axis of the passageway; and
a second set of ribs extends along said outer surface of said first body portion substantially perpendicular to said longitudinal axis of said first passageway.

16. A reinforced pipe fitting according to claim 15, wherein
a third set of ribs extends along said second body portion substantially parallel to a longitudinal axis of said second passageway.

17. A reinforced pipe fitting according to claim 14, wherein
a first end portion of said first body portion extends from said first annular ring to said first end; and
a first lip extends inwardly at said first end;
wherein said first annular ring, said first end portion and said first lip have a substantially Z-shaped configuration to increase stiffness of said first bell portion of said pipe fitting.

18. A reinforced pipe member according to claim 17, wherein
a second end portion of said first body portion extends from said second annular ring to said second end; and
a second lip extends inwardly at said second end;
wherein said second annular ring, said second end portion and said second lip have a substantially Z-shaped configuration to increase stiffness of said second bell portion of said pipe fitting.

19. A reinforced pipe member according to claim 18, wherein
a third end portion of said second body portion extends from said third annular ring to said third end; and
a third lip extends inwardly at said third end;
wherein said third annular ring, said third end portion and said third lip have a substantially Z-shaped configuration to increase stiffness of said second bell portion of said pipe fitting.

20. A reinforced pipe member according to claim 14, wherein
said first body portion has a central portion between said first and second ends having a first outer diameter less than second and third outer diameters at said first and second ends; and
a majority of said first and second sets of ribs extend along said central portion of said first body portion.
